(19) United States
(12) Patent Application Publication
(10) Pub. No.: US 2024/0375200 A1
(43) Pub. Date: Nov. 14, 2024

(54) ELECTROCHEMICAL TREATMENT DEVICE

(71) Applicant: ENSITECH IP PTY LTD, New South Wales (AU)

(72) Inventor: Clive Stuart WHITE, New South Wales (AU)

(21) Appl. No.: 18/691,910

(22) PCT Filed: Sep. 19, 2022
(86) PCT No.: PCT/AU2022/051126

§ 371 Date: Mar. 14, 2024

(30) Foreign Application Priority Data
Sep. 17, 2021 (AU) 2021902996

(51) Int. Cl. B23H 3/04; B23H 3/02; C25F 1/00; C25F 3/02; H02M 7/5387

(52) U.S. Cl. CPC B23H 3/04; B23H 3/02; C25F 1/00; C25F 3/02; H02M 7/5387

(57) ABSTRACT

The present invention relates to a device comprising a device casing and a first and second flexible contact extending from the casing, each comprising a mounting means and a flexible applicator portion extending therefrom, wherein the first and second flexible contacts are each adapted to receive conductive fluid and subsequently to apply the conductive fluid to a surface, and one of the first and second flexible contacts is positively charged, and the other is negatively charged, relative to one another.

### PRIORITY DETAILS

The present application claims priority from AU 2021902996, filed in Australia on 17 Sep. 2021, the entirety of which is incorporated herein by reference.

### TECHNICAL FIELD

The present invention relates generally to the field of treating conductive surfaces, and more particularly to the field of devices for electrochemically treating conductive surfaces.

### BACKGROUND

Electrochemical reactions are used for a variety of processes on metallic surfaces, such as to clean weld tint after assembly, to electropolish the surface, to deposit or plate materials onto the surface, or to electrochemically etch a stencilled design into the surface. The process requires that an electrical circuit is completed in the presence of a conductive fluid, which means that the conductive surface must be electrically connected to both of the opposing terminals of an electrical power source. These connections are typically made through the use of a pair of opposing electrodes—for convenience, these will be referred to hereafter as the ‘work’ electrode and a ‘return’ electrode to denote that the electrodes are connected to opposing power source terminals. The electrochemical processes require that the work electrode is either positively or negatively charged relative to the conductive surface and return electrode. The particular charge of the work electrode will depend upon the nature of the conductive surface, the desired electrochemical process and the conductive fluid.

It is well known that, if conductive fluid is present at both the work and return electrodes, then opposing electrochemical reactions will occur proximal to both electrodes—one desirable, and the other potentially undesirable. However, if it is desired for only one of these electrochemical reactions to occur, then only the work electrode should conduct electricity through the conductive fluid; the return electrode should be a “direct return electrode”, in that it is directly connected to the conductive surface.

The typical prior art electrochemical cleaning/etching/marking tool comprises a contacting implement that serves as the work electrode (sometimes referred to as a ‘wand’) and conductive fluid applicator, and a grounding clamp that is fixed directly onto the conductive surface to provide a direct return electrode. The contacting implement and grounding clamp are connected to opposing terminals of a power source. So long both as the grounding clamp is connected, touching the contacting implement along with conductive fluid to the conductive surface allows the circuit to complete and the desired electrochemical reaction to be induced.

Some alternate prior art arrangements may utilise a direct return electrode that relies on pressure from the user and a spring in order to maintain a return connection to the workpiece, while others may rely on a conductive workbench to act as a direct return electrode and maintain an electrical connection with the workpiece.

The skilled person will appreciate that, in general, applying or ‘plating’ material onto a conductive surface requires that the work electrode is positive with respect to the conductive surface, while removing material (such as occurs during a cleaning or polishing process) generally requires that the work electrode is negative with respect to the conductive surface. However, the skilled person will appreciate that the electrochemical principles are the same regardless of what effect the user is seeking—an electrical circuit must still be established, and conductive fluid must still be applied.

Prior art electrochemical cleaning/etching/marking tools vary in size, shape and arrangement of work electrodes, and may carry various advantages or disadvantages. However, each electrochemical cleaning/etching/marking tool requires the presence of a grounding clamp or other form of direct return electrode. Unfortunately the various prior art direct return electrode designs each represent significant limitations placed upon the user. For instance, use of a grounding clamp limits the mobility of the user—the grounding clamp is tethered to the electrochemical cleaning/etching tool power source via cable, and in order to move beyond the reach of said cable, the user must detach and re-attach the grounding clamp in a new spot. Additionally, not all surfaces provide easy-to-reach protrusions that the grounding clamp may be properly attached to in order to function; for example, large, smooth metal surfaces such as the inside of silos or water tanks may be devoid of suitable protrusions for receiving a grounding clamp. In a similar vein, spring-pressure direct return electrodes require constant attention from the user to maintain the necessary pressure. Finally, prior art electrochemical cleaning/etching/marking tools that rely upon conductive workbenches limit the user in that they can only work on projects placed directly on the workbench—such prior art tools are essentially completely immobile.

There is therefore a need to provide an electrochemical cleaning/etching device that provides an improvement in mobility and/or portability thereof, or at least overcomes some of the shortcomings of the prior art. In particular, it is an object of the invention to provide an electrochemical cleaning/etching device that does not require a separate ground clamp or other form of separate, direct-return electrode that tethers the user to a particular area or otherwise restricts them.

### DISCLOSURE OF THE INVENTION

In a first aspect, the present invention relates to a device comprising a device casing and a first and second flexible contact extending from the casing, each comprising a mounting means and a flexible applicator portion extending therefrom, wherein the first and second flexible contacts are each adapted to receive conductive fluid and subsequently to apply the conductive fluid to a surface, and one of the first and second flexible contacts is positively charged, and the other is negatively charged, relative to one another.

In an embodiment, power received by the first and second flexible contacts from the power source may be alternating current (AC) power, such that the first flexible contact alternates between being positively and negatively charged, and the second flexible contact alternates between being negatively and positively charged, said alternating of each of the first and second flexible contacts occurring simultaneously and in opposing directions.

In an embodiment, the power source may be an alternating current (AC) power source.

In an alternate embodiment, the power source may be a direct current (DC) power source, and the device may further comprise a switch unit between the power source and the first and second flexible contacts, the switch unit being electrically connected to a voltage-out terminal, a ground terminal, and the first and second flexible contacts, and a switch controller connected to the switch unit and having a charge polarity period, the switch unit has a first configuration wherein the first flexible contact is positively charged, and the second flexible contact is negatively charged relative to one another, and a second configuration wherein the first flexible contact is negatively charged, and the second flexible contact is positively charged relative to one another, and the switch controller is configured to periodically toggle the switch unit between the first and second configurations at a rate determined by the toggle period.

In an embodiment, the device may further comprise a DC-DC converter electrically connected to the power source and the switch unit, the voltage-out terminal and the ground terminal are respective terminals of the DC-DC converter, and the DC-DC converter is configured to: receive a constant voltage input from the power source, convert the constant voltage input into a pulsing voltage output, and provide the pulsing voltage output to the switch unit via the voltage-out terminal, further wherein the pulsing voltage output comprises a voltage waveform having a repeating pattern formed by alternating maximum and minimum voltages and having a pulse period, and the charge polarity period is substantially equal to an integer multiple of the pulse period. In an embodiment, the charge polarity period may be substantially equal to an odd integer multiple of the pulse period.

In an embodiment, the pulsing voltage output may comprise a voltage waveform having an asymptotic slope at minimum voltages thereof and otherwise having a non-asymptotic slope, and a timing of the switch unit being toggled by the switch controller is substantially aligned with the minimum voltages. In an embodiment, the voltage waveform may be a rectified full-wave sine waveform.

In an embodiment, the switch unit may comprise an array of switches, the array comprising: a first switch forming a closable circuit segment between the voltage-out terminal and the first flexible contact, a second switch forming a closable circuit segment between the voltage-out terminal and the second flexible contact, a third switch forming a closable circuit segment between the ground terminal and the first flexible contact, and a fourth switch forming a closable circuit segment between the ground terminal and the second flexible contact, further wherein toggling the switch unit to the first configuration comprises closing the first and fourth switches and opening the second and third switches, and toggling the switch unit to the second configuration comprises opening the first and fourth switches and closing the second and third switches.

In an alternate embodiment wherein the power source is a direct current (DC) power source, the first flexible contact may comprise a contacting area substantially smaller than a contacting area of the second flexible contact. In an embodiment, the contacting area of the first flexible contact may be at least two times smaller than the contacting area of the second flexible contact.

In an embodiment, the DC power source may be a battery, power cell, fuel cell or other self-contained DC power source.

In an embodiment, at least one of the first and second flexible contacts may comprise a roller having a roller mount and a rolling element formed of an absorbent material mounted to the roller mount, the rolling element being adapted to receive the conductive fluid and subsequently to apply the conductive fluid to the surface.

In an embodiment, the roller may be a split roller having a first rolling element portion arranged to form the first electrode and a second rolling element portion arranged to form the second electrode, the split roller is electrically connected to the power source, and the first and second rolling element portions are electrically isolated from one another.

In an embodiment, at least one of the first and second flexible contacts may comprise an absorbent pad adapted to receive the conductive fluid and subsequently to apply the conductive fluid to the surface.

In an embodiment, at least one of the first and second flexible contacts may comprise a brush. In an embodiment, the brush may comprise conductive filaments.

In an embodiment, the device may further comprise a partitioning element formed of non-conductive material arranged to prevent the first or second flexible contact directly contacting the other flexible contact. In an embodiment, the partitioning element may comprise a shroud that at least partially extends around at least one of the first and second flexible contacts.

In an embodiment, the power source may be an on-board power source contained within or mounted to the device casing. In an embodiment, the on-board power source may be within a power source housing that is detachably mounted to the device casing.

In an alternate embodiment, the power source may be in a power source housing that is spaced apart from and electrically connected to the device casing.

In an embodiment, the device may further comprise a fluid conduit arranged to provide the conductive fluid from a fluid source to each of the first and second flexible contacts. In an embodiment, the fluid source may be a fluid reservoir contained within or mounted to the device casing. In an embodiment, the fluid reservoir may be detachable from the device casing. In an embodiment wherein the power source is in a power source housing that is detachably mounted to the device casing, the fluid reservoir may be located within the power source housing.

An embodiment of the device, when used to electrolytically clean and passivate a weld in the conductive article. An embodiment of the device, when used to electrochemically etch a design, pattern or other form of marking into a surface of the conductive article.

Further embodiments or variations of the invention may be disclosed herein or may otherwise become apparent to the person skilled in the art through the following disclosure. These and other embodiments are considered to fall within the scope of the invention.

### DESCRIPTION OF FIGURES

Embodiments of the present invention will now be described in relation to figures, wherein:

FIGS. 1A & 1B depict an embodiment of the invention;

FIG. 2 depicts desired and undesired reactions;

FIGS. 3-5 are circuit diagrams for alternate embodiments of the invention;

FIGS. 6A-6C are Voltage Waveform graphs for an embodiment of the invention;

FIGS. 7 & 8 are circuit diagrams for embodiments of the invention comprising switch units;

FIGS. 9A-10C are Voltage Waveform graphs for embodiments of the invention comprising switch units;

FIGS. 11A & 11B depict alternate embodiments of the invention; and

FIGS. 12-16 depict various embodiments of the first and/or second flexible contacts.

### DETAILED DESCRIPTION OF PREFERRED EMBODIMENTS

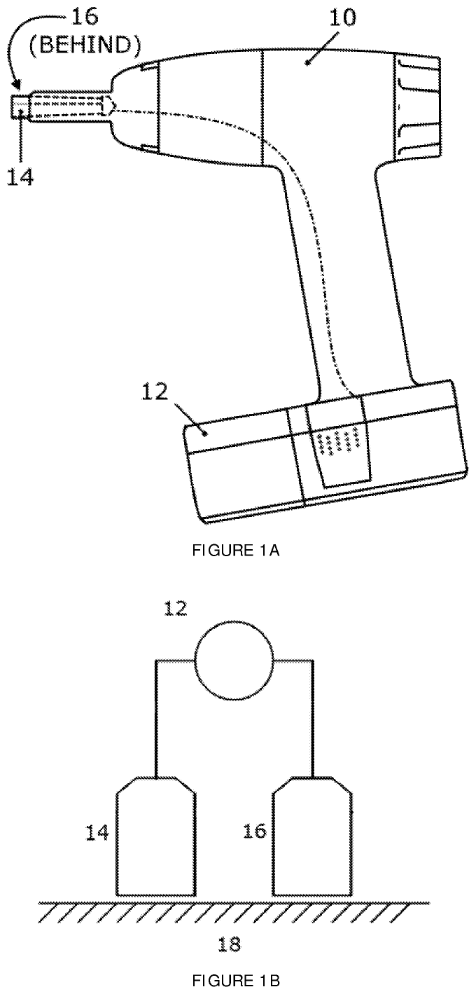

In a first aspect, the present invention relates to a device for applying a conductive fluid to a conductive surface, so as to clean, passivate, etch or otherwise treat the conductive surface. FIGS. 1A & 1B depict an embodiment of the invention, wherein FIG. 1A is a visual depiction thereof and FIG. 1B is a circuit diagram thereof. The depicted embodiment of the device comprises a device casing 10, and a first and second flexible contact 14, 16 extending from the device casing. The first and second flexible contacts 14,16 are in electrical communication with opposing terminals of a power source 12 (said electrical connection is depicted by the dot-and-dash line in FIG. 1A), such that one of the flexible contacts will be positively charged and the other will be negatively charged, relative to one other, and are each configured to be able to carry conductive fluid in some manner. The first and second flexible contacts 14, 16 may comprise a mounting means for affixing said flexible contact to the device casing 10, and a flexible applicator portion configured to carry the conductive fluid.

As used herein, the term ‘charge polarity’ refers to whether an element is positively or negatively charged. As used herein and unless otherwise explicitly specified, identification of the charge polarity of either flexible contact 14,16 should be interpreted as identification relative to the other flexible contact. For example, if the first flexible contact is positively charged and the second flexible contact is grounded, the second flexible contact is ‘negatively charged’ relative to the first flexible contact.

As the circuitry diagram of FIG. 1B shows, there is no direct electrical connection between the first and second flexible contacts 14, 16. Upon applying the conductive fluid to a conductive surface 18 with the first and second flexible contacts 14, 16, an electrical circuit is completed through the conductive surface, such that a voltage generated by power source 12 causes an electric current to flow between the first and second flexible contacts through the conductive surface 18 (and any conductive fluid that may be present). The power source 12 may be any particular power source that is capable of providing a sufficient voltage. The power source 12 is depicted in FIG. 1A as a portable battery pack, but this is exemplary only.

As the skilled person will appreciate, electrochemical processes such as weld cleaning, surface passivation and electrochemical etching or marking all require that a particular conductive fluid is present and that a circuit be formed to enable electricity to flow, thereby driving the electrochemical reactions between the ions dissolved in the conductive fluid and the conductive surface 18. As the device comprises oppositely-charged first and second flexible contacts 14, 16, both of which are adapted to be able to carry conductive fluid, then either flexible contact is able to serve as both a ‘work electrode’ and a ‘return electrode’, depending upon the desired electrochemical reaction and the relative charges of the flexible contacts. This may be contrasted to prior art arrangements that utilise a grounding clamp or spring mechanism, which are unable to act as ‘work electrodes’ due to being unable to carry or apply the conductive fluid and connect directly to the conductive surface 18, limiting the flow of electrical current through any conductive fluid that may be present proximal thereto.

In at least one embodiment of the invention there may be multiple first flexible contacts 14 electrically arranged in parallel to one another, and/or multiple second flexible contacts 16 electrically arranged in parallel to one another. These embodiments are not considered to be a departure from the scope of the invention, and any reference to one first or second flexible contact 14, 16 should be considered to be equally applicable to multiple first or second flexible contacts unless otherwise specified.

It is considered that embodiments of the present invention may enable a user to electrolytically clean and passivate a weld, electrochemically etch a design, pattern or other form of marking on a conductive surface of an article, without the need for a grounding clamp, grounding spring mechanism or conductive workbench. This may enable the user to use the device with substantially improved mobility and flexibility compared to a prior art tool that requires a grounding clamp and thus is tethered in place. The user may also be able to use an embodiment of the device on ladders, in a harness, or in other difficult-to-access or restricted-movement situations, without the risk of the grounding clamp and cable fouling their movement.

The skilled person will appreciate that electrochemical processes require a particular voltage potential in order to occur at a useful rate. In at least one embodiment, the power source 12 may be a power source capable of providing at least 12 volts. In a further embodiment, the power source 12 may provide at least 18 volts.

### Desired and Undesired Reactions

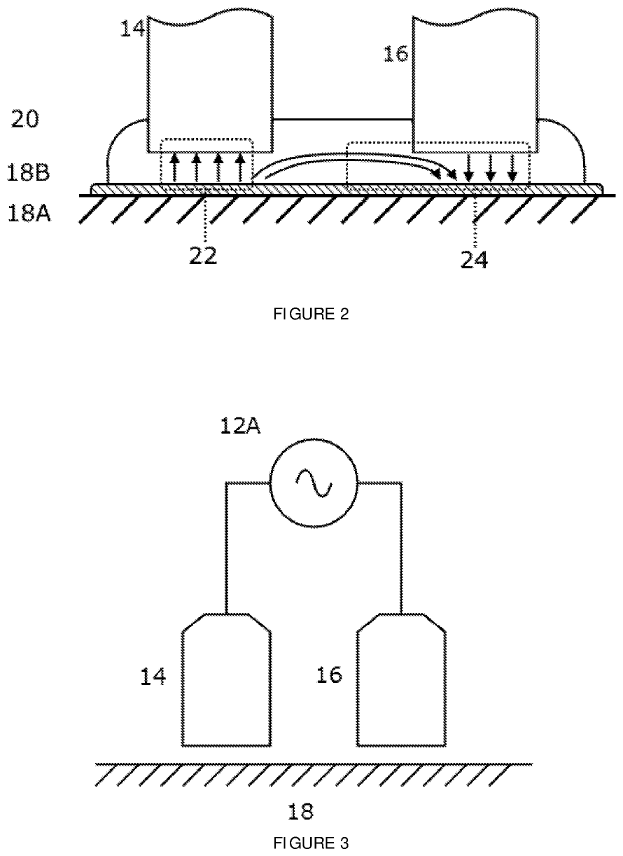

With reference to FIG. 2, depicted is a portion of an embodiment of the present invention arranged for use in cleaning or polishing a conductive surface. Shown are the first and second flexible contacts 14, 16 the conductive surface 18, comprising bulk material 18A and a surface layer 18B on top, and the conductive fluid 20. In some embodiments, the surface layer 18B may be oxidised material, weld tint or other depositions on the conductive surface 18 and thus covering the bulk material 18A. In other embodiments (not depicted), the surface layer 18B may be an upper layer of the conductive surface 18 that is being removed to expose the underlying bulk material 18A, such as through an etching process. Although not depicted, the person skilled in the art will appreciate that the flexible contacts are oppositely charged relative to one another, and that the appropriate charge polarity for the desired reaction will depend upon the nature of the conductive surface, the particular electrochemical process being applied thereto, and the type of conductive fluid being employed. For simplicity of explanation, the flexible contact 14, 16 that is appropriately charged to promote the desired reaction 22 may be referred to herein as the “active flexible contact”.

As both the first and second flexible contacts 14, 16 are in contact with conductive fluid, a reaction process 22, 24 takes place at each flexible contact. The reaction process that occurs at each flexible contact depends on the charge polarity thereof with respect to the conductive surface and the other flexible contact, the natures of which are well known in the art. Positively-charged ions in solution within the conductive fluid will migrate away from the positively charged flexible contact, through the conductive fluid and towards the conductive surface and the negatively charged flexible contact. Similarly, negatively-charged ions in solution will migrate away from the negatively-charged flexible contact and towards the positively-charged flexible contact and the conductive surface.

Generally, only one of these processes will be the desired process 22—which is depicted in example FIG. 2 as surface layer 18B entering solution within the conductive fluid 20, migrating towards the appropriately-charged first flexible contact 14, and ultimately depositing thereupon. Charge-balancing processes 24 may comprise other reactions such as gas or water evolution, which are non-detrimental, but may also comprise the reverse of the desired process 22. For example, as depicted by the curved arrows, charge-balancing process 24 may also comprise re-deposition of material drawn into solution from surface layer 18B back onto the conductive surface 18, which is undesirable. Undesirable forms of the charge-balancing process 24 may also comprise dissolution of material deposited upon the second flexible contact 16, movement of these ions to the conductive surface 18, and subsequent deposition thereupon.

The person skilled in the art will appreciate that the nature of the conductive surface 18 (including the natures of the bulk material 18A and surface layer 18B), the conductive fluid 20 and the desired and undesired processes 22, 24 may vary between applications of an embodiment of the invention. The skilled person will further appreciate that these various natures are, in general, well known in the art.

### Desired Process Promotion/Undesired Process Amelioration

The time it takes for an electrochemical reaction to occur at the respective reaction sites depends on the velocity of movement of the ions in solution and the length of the path the ion needs to travel. The ion velocity depends on the nature of the ion, concentration of the solution, the temperature, and the applied potential gradient. With further reference to FIG. 2 and without limiting the scope of the invention through theory, it is considered that when the desired process 22 comprises dissolution of surface material (such as through etching, cleaning and/or polishing), the ‘path length’ of the desired process 22 is the distance between the first flexible contact 14 and the surface layer 18B immediately proximal thereto.

Conversely, one form of the undesired process (being represented by the curved arrows in charge-balancing process 24) requires that dissolved ions of the surface layer 18B first migrate through the conductive fluid 20 over towards the second flexible contact 16, and only then can they subsequently migrate to the conductive surface 18 for deposition thereupon, as the dissolved ions must first leave the influence of the first flexible contact 14. An alternate form of the undesired process (dissolution of material that is on the second flexible contact 16 and subsequent deposition upon the conductive surface 18) requires three steps: dissolution, migration and deposition. It has been found that, in general, the undesired process takes longer to complete as the desired process 22 does. In some embodiments, the undesired process may take at least twice as long as the desired process.

In arrangements (not depicted) wherein the desired process 22 is marking through deposition or plating of material onto the conductive surface, the desired process 22 draws upon ions that are already dissolved in the conductive fluid 20. Ions move away from the appropriately-charged flexible contact and towards the conductive surface 18 as well as the oppositely-charged other flexible contact. Deposition of the ions upon the other flexible contact, or drawing of the material deposited on the conductive surface 18 back into solution, are typically undesired processes. As with the example discussed previously, it is envisaged that completion of the undesired process (movement of ions from, e.g., the first flexible contact 14 or the conductive surface 18 to the second flexible contact 16 and subsequent deposition thereupon) takes longer to complete than the desired process 22.

Based upon the above, a particular electrochemical process (i.e. the desired process 22 and its related charge-balancing and/or undesired process 24), applied to a conductive surface 18 having a particular nature and utilising a particular conductive fluid 20 and applied voltage, will have a particular Desired Process Completion Time (T_{C}) that obeys the following equation:

$${T}_{D , min} \leq {T}_{c} < {T}_{U}$$

Wherein T_{D,min} is the minimum time required for the desired process 22 to proceed, while T_{U} is the time required for the undesired process 24 to proceed. The skilled person will appreciate that T_{C} is a range of time values between T_{D,min} and T_{U}.

In an embodiment, promotion of the desired reaction 22 and limitation of the charge-balancing reaction(s) 24 may be able to be achieved by rapidly switching the charge polarity of the first and second flexible contacts 14, 16, such that they will alternate between being positively or negatively charged relative to one another. Without limiting the scope of the invention through theory, it is envisaged that by switching the charge polarities of the first and second flexible contacts 14, 16 such that each unbroken period of time spent with a particular charge polarity is greater than the minimum time required for the desired process, but less than the time required for the undesired process, then the desired process 22 may be selectively promoted over the undesired process, thereby reducing, negating or at least ameliorating the need for a direct-return electrode such as a ground clamp.

With respect to cleaning, etching or polishing arrangements, for ease of explanation it will be described in terms of an arrangement wherein the surface layer 18B dissolves to form positively-charged ions—such as when the surface layer being removed comprises a metal. The device is powered such that the first flexible contact 14 is negatively charged, while the second flexible contact 16 is positively charged. Surface layer 18B is drawn into solution and ions thereof migrate towards the first flexible contact 14, with a portion migrating across the conductive fluid 20, leaving the influence of the first flexible contact 14 and subsequently becoming influenced by the positively-charged second flexible contact. However, before these ions may be re-deposited, the charge polarity of the power source 12 is reversed, such that the first flexible contact 14 is now positively charged and the second flexible contact 16 is negatively charged.

With respect to marking or electroplating arrangements, by way of explanatory example the device may be powered such that the first flexible contact 14 is positively charged, while the second flexible contact 16 is negatively charged. Positively-charged ions that are already dissolved in the conductive fluid 20 are urged by the positively-charged first flexible contact 14 to deposit upon the conductive surface 18 as well as to migrate from the first flexible contact towards the second flexible contact 16. However, by reversing the charge polarity of the flexible contacts 14, 16 before the ions can plate thereupon, plating or depositing of the dissolved material upon the now-positively charged second flexible contact 16 is reduced, inhibited or at least ameliorated.

Although the above examples are described with reference to positively- charged ions being drawn into or deposited out of solution, the skilled person will appreciate that this is exemplary only and that adapting the device for drawing or depositing negatively-charged ions into or out of solution is within the scope of the invention as disclosed herein.

In a further embodiment, the device may be configured such that a voltage at the first flexible contact 14 when the first flexible contact is positively charged, and a voltage at the second flexible contact 16 when the second flexible contact is positively charged, are substantially similar in magnitude to one another. In an alternate further embodiment, the device may be configured such that a voltage at the first flexible contact 14 when the first flexible contact is negatively charged, and a voltage at the second flexible contact 16 when the second flexible contact is negatively charged, are substantially similar in magnitude to one another. In either embodiment, the device may be further configured such that each of the flexible contacts 14, 16 spends substantially similar time positively or negatively charged, so as to inhibit or at least ameliorate any ‘DC bias’ that may occur.

The unbroken period of time spent charged to a particular charge polarity may be referred to herein as a ‘charge polarity period’ (T_{P})—i.e., the period of time between the flexible contacts 14, 16 switching charge polarity. In an ideal embodiment, the charge polarity period T_{P} is equal to the Desired Process Completion Time T_{C}.

In an alternate embodiment, the first flexible contact 14 may be configured to promote the desired reaction 22 by comprising a decreased contact area compared to the second flexible contact 16. As the skilled person will appreciate, while the overall rates of reaction of each of the desired reaction 22 and charge-balancing reaction(s) 24 are at least partially dependent upon the total current flowing through the completed circuit, the rate the desired reaction 22 or charge-balancing reaction(s) 24 per unit area is dependent upon current density. As such, by decreasing a contact area of the first flexible contact 14 to be substantially smaller than a contact area of the second flexible contact 16, such that the current density immediately proximal to the first flexible contact 14 is increased relative to the current density immediately proximal to the second flexible contact 16, thereby increasing the rate of the desired reaction 22 per unit area. Conversely, any product of the charge-balancing reaction(s) 24 will be spread over a relatively greater surface area without an increase in quantity produced, allowing any undesired depositions to be gradually thinned out and substantially removed. In a further embodiment, the contact area of the first flexible contact 14 may be at least two times that of the second flexible contact 16. The skilled person will appreciate that the ratio between the contact areas of the first and second flexible contacts 14, 16 may also be dependent upon various factors, such as the reaction rate per unit area of the desired and undesired reactions 22, 24.

### Power Sources

In one embodiment and with reference to FIG. 3, switching of the charge polarity of the first and second flexible contacts 14, 16 may be enabled by utilising an alternating current (AC) power source 12A. It is considered that AC power sources offer a benefit in that promotion of the desired reaction 22 through charge polarity switching may be achieved without requiring complex electrical circuitry. As the skilled person will appreciate, an AC power source 12A will have an associated power output frequency, the inverse of which will be the power output period (Tₒᵤₜₚᵤₜ). The power output period is equal to the length of time that it takes for a particular flexible contact 14, 16 to completely cycle through charge polarities, e.g. the time from being positively charged to negatively charged and back again, and therefore the power output period Tₒᵤₜₚᵤₜ is double the charge period T_{P}. As such, in a further embodiment the AC power source 12A may be selected or configured such that its power output is of a frequency (f) that obeys the following criterion:

$$\frac{1}{f} = {T}_{o u t p u t} = 2 \times {T}_{P} = 2 \times {T}_{c}$$

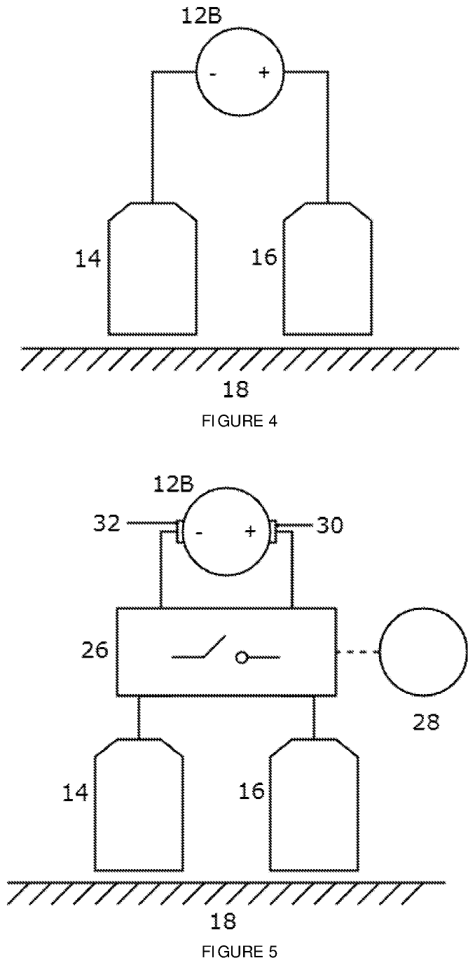

AC power sources are not always practical, especially where portability is desired. As such, in an alternate embodiment of the present invention and with reference to FIG. 4, the power source 12 may be a direct current (DC) power source 12B. It is considered that the use of a DC power source 12B may be particularly beneficial in providing an embodiment of the device that is portable. In some embodiments, the DC power source 12B may be one or more of a fuel cell, a battery, a power cell, or an alternate form of a self-contained DC power source.

Embodiments of the invention utilising a DC power source 12B may be able to be configured to promote the desired reaction 22 by decreasing the contact area of the first flexible contact 14.

### Charge Polarity Switching With DC Power Source

DC power sources 12B are not natively capable of enabling promotion of the desired reaction 22 through charge polarity-switching. Therefore, in order to enable this functionality without sacrificing the potential portability offered by a DC power source 18B such as a fuel cell or battery pack, in an alternate further embodiment and with reference to FIG. 5, the device may further comprise a switch unit 26 between the DC power source 12B and the flexible contacts 14, 16, and a switch controller 28 connected to the switch unit. The switch unit may be electrically connected to a voltage-out terminal 30, a ground terminal 32, and the first and second flexible contacts 14, 16. In such an embodiment, the switch unit 26 may have a first configuration wherein the first flexible contact 14 is positively charged and the second flexible contact 16 is negatively charged, and a second configuration wherein the first flexible contact is negatively charged and the second flexible contact is positively charged. The switch controller 28 may be configured to periodically toggle the switch unit 26 between the first and second configurations according to the charge polarity period T_{P}, such that T_{P}=T_{C}.

In some embodiments, the switch controller 28 may toggle the switch unit 26 by periodically emitting a single ‘toggle’ signal. In such an embodiment, the charge polarity period may be equal to the ‘clock period’ of the switch controller 28, being the period of time between signal pulses. In some alternate embodiments, the switch controller 28 may toggle the switch unit 26 by alternately emitting two different signals, being a ‘toggle from first configuration to second’ signal and a ‘toggle from second configuration to first’ signal. As the skilled person will appreciate, in such an embodiment the ‘clock period’ of the switch controller would be the period of time between two sequential instances of the same signal (e.g. two sequential instances of emitting a ‘toggle from first configuration to second’ signal) and would therefore be twice the length of the charge polarity period.

In an embodiment of the invention comprising a switch unit 26 and switch controller 28, the first and second flexible contacts 14, 16 may have respective contact areas that are substantially similar in size, so as to ameliorate or otherwise inhibit the inducement of DC voltage bias during use of the device. In the embodiment depicted in FIG. 5, the voltage-out terminal 30 and ground terminal 32 are depicted as respective terminals of the DC power source 12B, however the skilled person will appreciate that other circuitry components may be positioned between the DC power source 12B and the switch unit 26. As used herein, the terms voltage-out terminal 30 and/or ground terminal 32 may refer to the respective terminals immediately ‘upstream’ or ‘downstream’ of the switch unit 26 (depending on whether the other circuit component is providing the voltage-out terminal 30 and/or ground terminal 32).

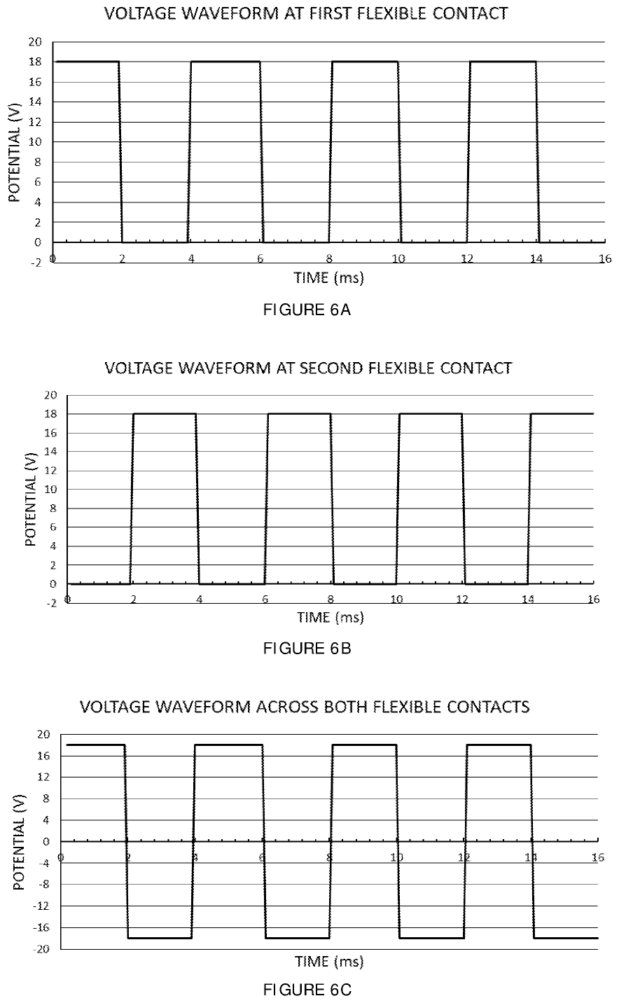

FIG. 6a depicts the electrode potential at the first flexible contact 14, while FIG. 6b depicts the electrode potential at the second flexible contact 16, when a switch unit 26 is implemented, for an 18-volt DC power source 12B and assuming no loss. Finally, FIG. 6c depicts the voltage across both flexible contacts 14, 16. Although the overall voltage waveform is rendered such that the first flexible contact 14 is the default ‘positive’ terminal, the skilled person will appreciate that this is convention only and does not limit the scope of the invention. As the skilled person may appreciate, the ‘peak-to-peak’ voltage across both contacts is 36 volts, double the voltage of the 18-volt DC power source 12B.

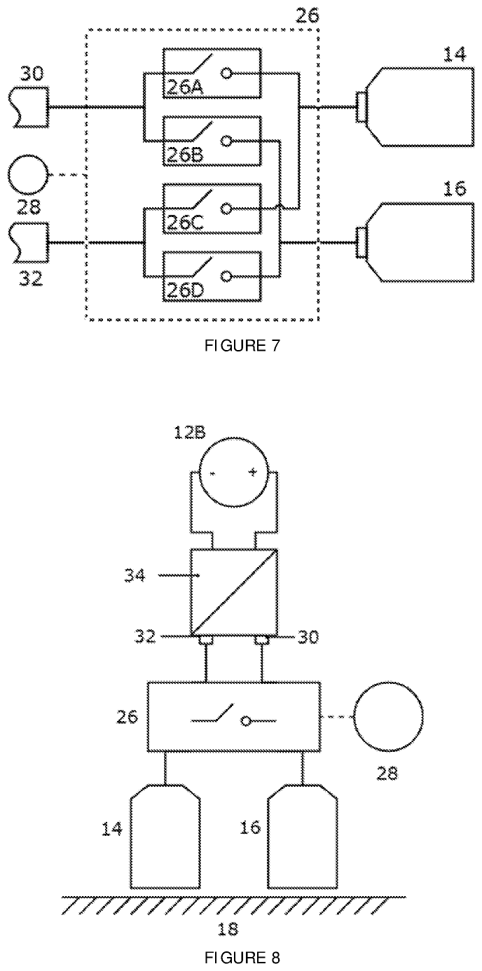

In an embodiment and with reference to FIG. 7, the switch unit 26 may comprise an array of switches, having at least a first switch 26A, a second switch 26B, a third switch 26C and a fourth switch 26D. The first switch 26A may form a closable circuit segment between the voltage-out terminal 30 and the first flexible contact 14, the second switch 26B may form a closable circuit segment between the voltage-out terminal 30 and the second flexible contact 16, the third switch 26C may form a closable circuit segment between the first flexible contact and the ground terminal 32, and the fourth switch 26D may form a closable circuit segment between the second flexible contact and the ground terminal. In such an embodiment, the switch controller 28 may be configured such that toggling the switch unit 26 to the first configuration comprises closing the first and fourth switches 26A, 26D and opening the second and third switches 26B, 26C, and toggling the switch unit to the second configuration comprises opening the first and fourth switches 26A, 26D and closing the second and third switches 26B, 26C, wherein a closed switch enables electricity to flow therethrough and an open switch inhibits the flow of electricity therethrough.

One or more of the switches 26A-D may comprise a transistor. One or more of the switches 26A-D may comprise a thyristor and diode connected in parallel. In an embodiment, the switch unit 26 may comprise a full-bridge inverter switch.

### Interference Mitigation

In at least one embodiment of the invention comprising a switch unit 26, the electrode potential at each of the first and second flexible contacts 14, 16 may be a square waveform. An example of each waveform is shown in FIGS. 6a and 6b, in which the switch controller 28 toggles the switch unit 26 between the first and second configurations every two milliseconds (i.e., T_{P}=2 ms). The skilled person will appreciate that the voltage and charge polarity period are selected arbitrarily and for example purposes only. When toggling at high frequencies, the rapid spike or dip in voltage that occurs at the edge of each ‘square’ in the waveforms depicted in FIGS. 6a-c can induce high levels of electromagnetic interference in nearby electrical circuits and other electronics, wherein the amount of generated electromagnetic interference is at least partially proportional to the instantaneous rate of change in voltage. While an embodiment of the present invention that produces electromagnetic interference may be suitable in some situations, it may not be adequate when the device is being used, for example, in areas with sensitive electronics.

In order to ameliorate this, an embodiment of the device may be configured to reduce the voltage across the first and second flexible contacts when the switch unit 26 is to be toggled, so that the instantaneous rate of change of voltage across the first and second flexible contacts 14, 16 caused by the toggling of the switch unit 26 is reduced, thereby reducing or ameliorating the amount of generated electromagnetic interference.

In an embodiment and with reference to FIG. 8, the device may further comprise a DC-DC converter 34 between the DC power source 12B and the switch unit 26. In at least the present embodiment, the voltage-out terminal 30 and ground terminal 32 that electrically connect to the switch unit 26 are respective terminals of the DC-DC converter. In at least the present embodiment, the DC-DC converter 34 may be configured to receive a constant voltage input from the DC power source 12B, convert the constant DC voltage input into a pulsing DC voltage output, and provide the pulsing DC voltage output to the switch unit 26 via the voltage-out terminal 30. The skilled person will appreciate that the DC-DC converter 34 is not producing AC output.

In a further preferred embodiment, the pulsing voltage output comprises a voltage waveform having a repeating pattern formed by alternating maximum and minimum voltages and having a pulse period (Tₚᵤₗₛₑ). As used herein, the term ‘pulse period’ refers to the period of time that it takes for the pulsing voltage output to repeat—for example, the length of time between two sequential maximum voltages, or two sequential minimum voltages.

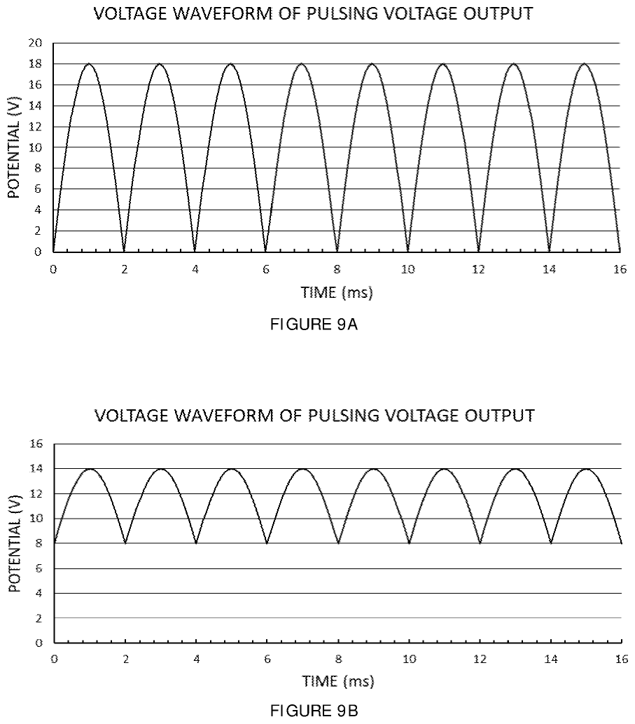

In a further preferred embodiment, the pulsing voltage output may comprise a voltage waveform that has an asymptotic slope at minimum voltages and otherwise has a non-asymptotic slope, such that the voltage waveform is substantially curved at non-minimum values of the voltage. An example of a waveform having asymptotic slope at minimum voltages and otherwise a non-asymptotic slope is depicted in FIG. 9A, wherein the pulse period Tₚᵤₗₛₑ of the depicted waveform is 2 ms. While the voltage waveform depicted in FIG. 9A comprises a minimum voltage of 0V, this is selected for example purposes only. The minimum voltage may be selected as a value above 0V, such as the voltage waveform of an alternate embodiment of a pulsing voltage output as depicted in FIG. 9B. The skilled person will appreciate that the voltages and pulse periods depicted in FIGS. 9A and 9B are for example purposes only.

In an embodiment, the charge polarity period T_{P} of the switch controller 28 is configured to be substantially equivalent to an integer multiple of pulse periods Tₚᵤₗₛₑ. In a further embodiment, the integer multiple of pulse periods an odd integer multiple. In a further embodiment, the odd integer multiple of pulse periods may be one, i.e., the charge polarity period T_{P} may be substantially equal to the pulse period Tₚᵤₗₛₑ.

In an embodiment, a timing of the switch unit 26 being toggled by the switch controller 28 may be substantially aligned with the minimum voltages so as to reduce the level of generated electromagnetic interference. As the voltage across the first and second flexible contacts 14, 16 is substantially reduced, upon inversion of charge polarity of said flexible contacts, the instantaneous rate of change of voltage will be significantly lowered. In a further embodiment, if the minimum voltage is at or near zero, so as to substantially entirely ameliorate the generation of electromagnetic interference.

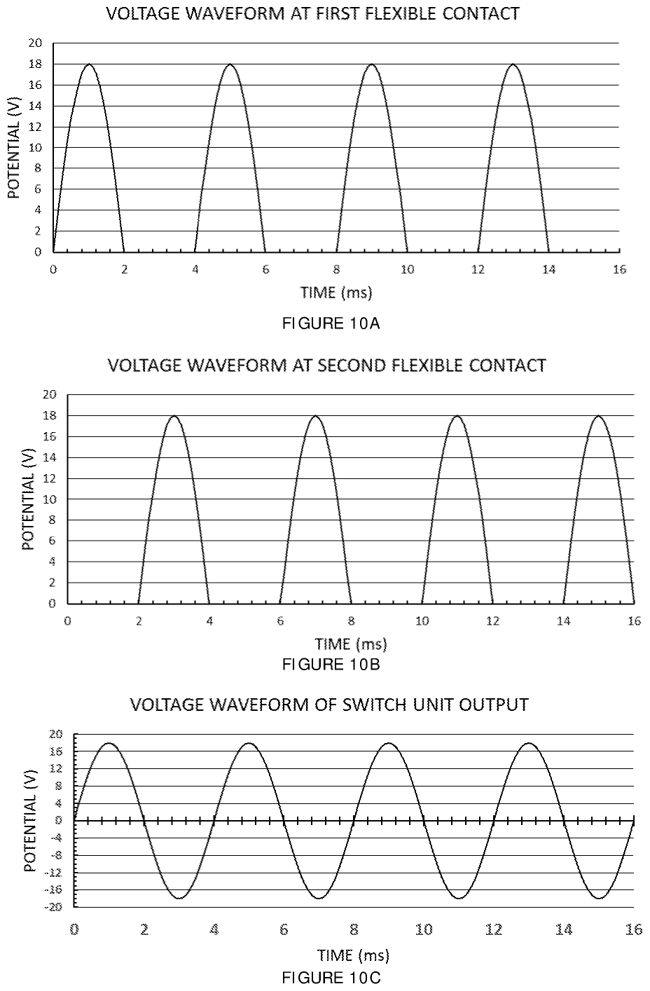

FIGS. 10A and 10B depict the voltage waveforms for the first flexible contact 14 and the second flexible contact 16, where the potential is measured as a voltage between the respective flexible contact 14, 16 and the conductive surface 18, while FIG. 10C depicts the voltage waveform of the device across the flexible contacts 14,16, based upon an example 18-volt DC power source 12B input. In FIG. 10C, the overall voltage waveform is rendered such that the first flexible contact 14 is the default ‘positive’ terminal, but the skilled person will appreciate that this is convention only and does not limit the scope of the invention.

Contrasting FIG. 6C to 10C, the skilled person may appreciate that the instantaneous rate of change of voltage is substantially reduced at each instance of toggling, and as a result generation of electromagnetic interference may be substantially ameliorated. Rather than the voltage across the first and second flexible contacts 14, 16 suddenly changing, the transition is smoothed out into a sinusoidal shape. This may be in addition to the reduction of generated electromagnetic interference achieved by reducing the voltage across the first and second flexible contacts 14, 16 immediately prior to toggling the charge polarity thereof.

As the skilled person may appreciate, the peak voltage values in FIGS. 10a and 10b are essentially identical to the voltage output of the DC power source 12B, such that the peak-to-peak voltage (based upon an 18-volt DC power source 12B input) is 36 volts. In the case of a voltage waveform substantially approaching a sine wave, the ‘useful’ voltage—being the RMS voltage—will be approximately 12.6 volts (18V*1/\sqrt{2}). It is considered that an embodiment of the device may thus be able to be compatible or usable with a typical 18V power tool battery pack, while still producing a high enough voltage and sufficient current to drive a desired electrochemical reaction at a useful rate.

### Power and Fluid Source Design

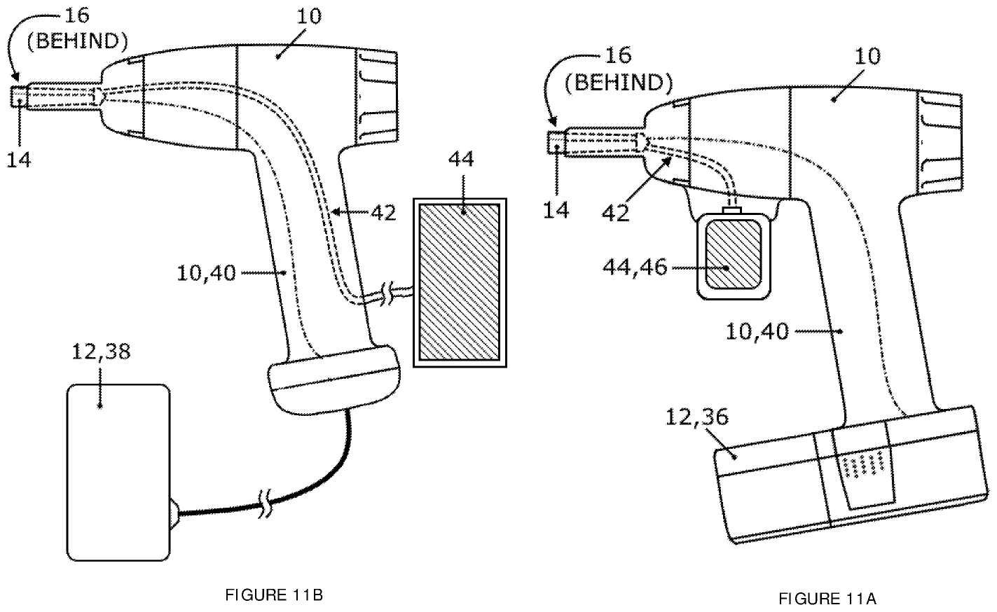

In an embodiment and with reference to FIG. 11A, the power source 12 may be on-board power source 36. In such an embodiment, the device may be a fully-portable device. In a further embodiment, the on-board power source 36 may be within a power source housing 38 that is detachable from a handle portion 40 of the device from which the first and second flexible contacts 14, 16 extend.

In an alternate embodiment and with reference to FIG. 11B, the power source 12 may be in a power source housing 38 that is spaced apart from and electrically connected to a handle portion 40 of the device from which the first and second flexible contacts 14, 16 extend. The power source housing 38 may be electrically connected to the handle portion of the device by one or more flexible cables. Such an embodiment may enable use of the device for extended periods of time.

In an embodiment, the device may further comprise a fluid conduit 42 that is arranged to deliver the conductive fluid, from a fluid source 44, to at least one of the first and second flexible contacts 14, 16. This may enable at least partially-continuous flow of the conductive fluid to the first and second flexible contacts 14, 16, removing or at least ameliorating a need to dip the first and second flexible contacts in a container of said conductive fluid. Delivery of conductive fluid through the fluid conduit 42 may be manual (e.g. actuated by a user-operated button or switch), or may be automatic. Delivery may be pressure driven, such as by one or more pump units. In a further embodiment, the fluid source may be a fluid reservoir 46 contained within or mounted to the device casing 10 and in fluid communication with the fluid conduit 42. In a further embodiment (not shown) wherein the device also comprises the power source 12 within a power source housing 38, the fluid reservoir 46 may be located within the power source housing.

### Flexible Contact Design

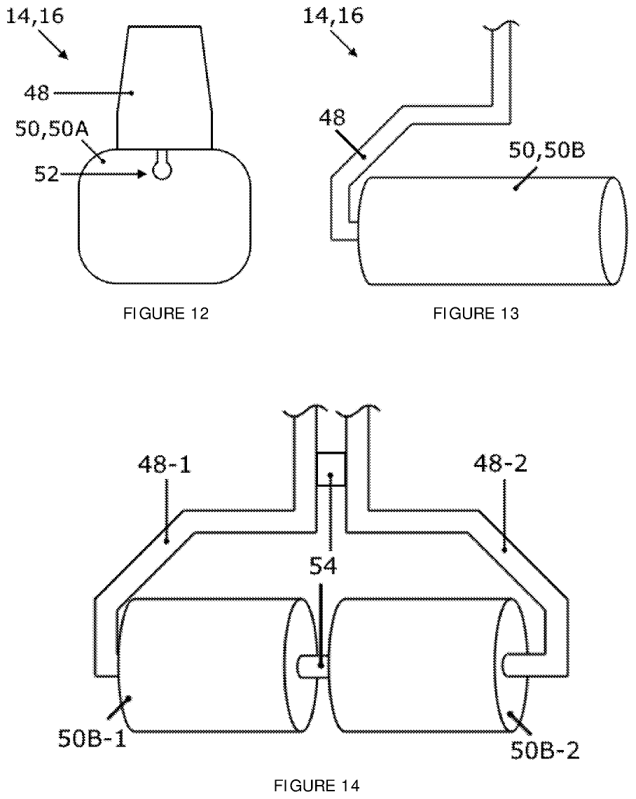

In general and with reference to FIG. 12, the first and second flexible contacts each comprise a mounting means 48 for mounting to the device casing 10 and receiving electrical current from the power source 12, and a flexible applicator portion 50 extending therefrom that is adapted to apply conductive fluid to the conductive surface 18. The first and second flexible contacts 14, 16 are further adapted so that electrical current can run from the power source 12, through the respective flexible contact and into the conductive fluid. In some embodiments, this may be achieved by a conductive element contacting or protruding into the flexible applicator portion 50, and thus into contact with the conductive fluid carried therein. In alternate embodiments, the flexible applicator portion 50 may be comprised of conductive material, thereby enabling electric current to travel therealong, either alongside or instead of electrical current travelling through the loaded conductive fluid. In some embodiments, the mounting means 48 may be adapted to receive conductive fluid through a fluid conduit 46.

With further reference to FIG. 12, in an embodiment the flexible applicator portion 50 may comprise an absorbent pad 50A on the end of the mounting means 48. The embodiment may also comprise a conductive element 52. The absorbent material serves as the fluid-carrying means, and carries the conductive fluid and allows its application to a conductive surface (not shown).

In an embodiment and with reference to FIG. 13, the flexible applicator portion 50 of at least one of the first and second flexible contacts 14, 16 may be a roller element comprising an absorbent material and mounted onto the mounting means 48. As with embodiments comprising an absorbent pad 50A, the absorbent material of the roller element 50B serves to carry the conductive fluid. In a further embodiment and with reference to FIG. 14, each of the first and second flexible contacts 14, 16 may be provided in the form of a split roller, having a first mounting means 48-1 and first roller element 50B-1 arranged to form the first flexible contact 14, and a second roller means 48-2 and second roller element 50B-2 arranged to form the second flexible contact 16. In an embodiment, the split roller may comprise one or more central portions 54 to provide some structural rigidity. In such an embodiment, the central portion 54 is non-conductive so as to ensure that the first and second roller elements 50B-1, 50B-2 are electrically isolated from one another.

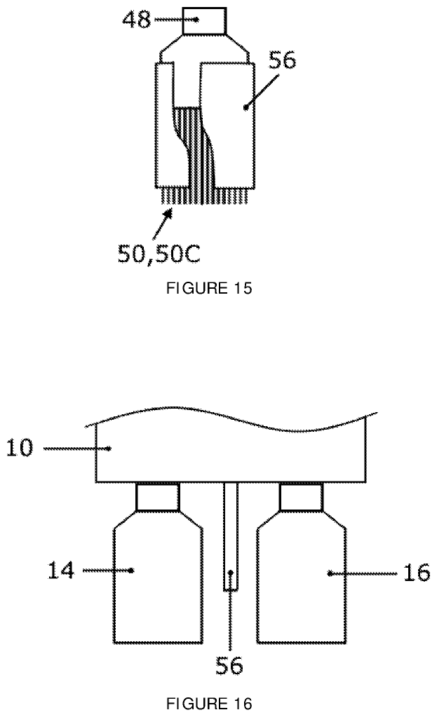

In an embodiment and with reference to FIG. 15, the flexible applicator portion 50 of at least one of the first and second flexible contacts 14, 16 may be a brush. In a further embodiment, the flexible applicator portion 50 of the brush may comprise conductive filaments 50C. In further embodiments, the brush may be extendable and/or retractable. Extension and/or retraction thereof may be manual, or may alternatively be driven by a motor. Extension and/or retraction may be automated by a switch controller based upon input of a sensor to sense an extent to which the brush has been worn down through use.

As the skilled person will appreciate, the flexible applicator portion 50 of the first and second flexible contacts 14, 16 are flexible. This helps to promote adequate and proper contact with the conductive surface 18 by both of the contacts 14, 16, which is necessary to ensure that the electrical circuit is completed. However, depending on size, type and arrangement of the first and second flexible contacts 14, 16, the flexible contacts may be at risk of flexing, bending or otherwise deforming towards one another. Should they come into direct contact with one another, the circuit may be prematurely completed and may lead to short-circuiting. In an embodiment and with reference to FIG. 16, the device may further comprise a partitioning element 56 formed of non-conductive material that is arranged to prevent the first or second flexible contact 14, 16 directly contacting the other flexible contact. In a further embodiment and with return reference to FIG. 15, the partitioning element 56 may comprise a shroud that at least partially extends around at least one of the first and second flexible contacts 14, 16. In some embodiments, the shroud may be extendable and/or retractable. The partitioning element 56 depicted in FIG. 15 is shown with a cut-out, but this is for explanatory and clarity purposes only.

While the invention has been described with reference to preferred embodiments above, it will be appreciated by those skilled in the art that it is not limited to those embodiments, but may be embodied in many other forms, variations and modifications other than those specifically described. The invention includes all such variation and modifications. The invention also includes all of the steps, features, components and/or devices referred to or indicated in the specification, individually or collectively and any and all combinations or any two or more of the steps or features.

In this specification, unless the context clearly indicates otherwise, the word “comprising” is not intended to have the exclusive meaning of the word such as “consisting only of”, but rather has the non-exclusive meaning, in the sense of “including at least”. The same applies, with corresponding grammatical changes, to other forms of the word such as “comprise”, etc.

Other definitions for selected terms used herein may be found within the detailed description of the invention and apply throughout. Unless otherwise defined, all other scientific and technical terms used herein have the same meaning as commonly understood to one of ordinary skill in the art to which the invention belongs.

Any promises made in the present document should be understood to relate to some embodiments of the invention, and are not intended to be promises made about the invention in all embodiments. Where there are promises that are deemed to apply to all embodiments of the invention, the applicant/patentee reserves the right to later delete them from the description and they do not rely on these promises for the acceptance or subsequent grant of a patent in any country.

1. A portable and handheld electrochemical treatment device, comprising:
a device casing; and
a first and second flexible contact extending from the casing, each comprising a mounting means and a flexible applicator portion extending therefrom, and each being electrically connected to a power source;
wherein the first and second flexible contacts are each adapted receive conductive fluid and subsequently to apply the conductive fluid to a surface;
the first and second flexible contacts receive power having a periodically changing voltage; and
the first flexible contact alternates between being positively and negatively charged relative to the second flexible contact, and the second flexible contact alternates between being negatively and positively charged relative to the first flexible contact;
said alternating of each of the first and second flexible contacts occurring simultaneously and in opposing directions.

2. (canceled)

3. The device of claim 1, wherein the power source is an alternating current (AC) power source.

4. The device of claim 1, wherein the power source is a direct current (DC) power source;
the device further comprises:
a switch unit between the power source and the first and second flexible contacts, the switch unit being electrically connected to a voltage-out terminal, a ground terminal, and the first and second flexible contacts; and
a switch controller connected to the switch unit and having a charge polarity period;
the switch unit has a first configuration wherein the first flexible contact is positively charged, and the second flexible contact is negatively charged relative to one another, and a second configuration wherein the first flexible contact is negatively charged, and the second flexible contact is positively charged relative to one another; and
the switch controller is configured to periodically toggle the switch unit between the first and second configurations at a rate determined by the charge polarity period.

5. The device of claim 4, wherein the device further comprises a DC-DC converter electrically connected to the power source and the switch unit;
the voltage-out terminal and the ground terminal are respective terminals of the DC-DC converter; and
the DC-DC converter is configured to:
(i) receive a constant voltage input from the power source;
(ii) convert the constant voltage input into a pulsing voltage output; and
(iii) provide the pulsing voltage output to the switch unit via the voltage-out terminal;
further wherein the pulsing voltage output comprises a voltage waveform having a repeating pattern formed by alternating maximum and minimum voltages and having a pulse period; and
the charge polarity period is substantially equal to an integer multiple of the pulse period.

6. The device of claim 5, wherein the charge polarity period is substantially equal to an odd integer multiple of the pulse period.

7. The device of claim 5 wherein the pulsing voltage output comprises a voltage waveform having an asymptotic slope at minimum voltages thereof and otherwise having a non-asymptotic slope; and
a timing of the switch unit being toggled by the switch controller is substantially aligned with the minimum voltages.

8. The device of claim 5, wherein the voltage waveform is a rectified full-wave sine waveform.

9. The device of claim 4, wherein the switch unit comprises an array of switches, the array comprising:
a first switch forming a closable circuit segment between the voltage-out terminal and the first flexible contact;
a second switch forming a closable circuit segment between the voltage-out terminal and the second flexible contact;
a third switch forming a closable circuit segment between the ground terminal and the first flexible contact; and
a fourth switch forming a closable circuit segment between the ground terminal and the second flexible contact;
further wherein toggling the switch unit to the first configuration comprises closing the first and fourth switches and opening the second and third switches; and
toggling the switch unit to the second configuration comprises opening the first and fourth switches and closing the second and third switches.

10. The device of claim 4, wherein the charge polarity period is equal to a desired process completion time;
further wherein the desired process completion time (T_{c}) is defined as follows:
T_{D,min}≤T_{c}<Tᵤ
T_{D,min} is a minimum time required for a desired process to proceed; and
Tᵤ is a time required for an undesired process to proceed.

11. (canceled)

12. (canceled)

13. The device of claim 4, wherein the DC power source is a battery, power cell, fuel cell or other self-contained DC power source.

14. The device of claim 1, wherein the flexible applicator portion of at least one of the first and second flexible contacts comprises a roller element comprising an absorbent material.

15. The device of claim 1, wherein the flexible applicator portion of at least one of the first and second flexible contacts comprises an absorbent pad on the end of the mounting means.

16. The device of claim 1, wherein the flexible applicator portion of at least one of the first and second flexible contacts comprises a brush.

17. The device of claim 16, wherein the brush comprises conductive filaments.

18. The device of claim 1, further comprising a partitioning element formed of non-conductive material arranged to prevent the first or second flexible contact directly contacting the other flexible contact.

19. The device of claim 18, wherein the partitioning element comprises a shroud at least partially extending around at least one of the first and second flexible contacts.

20. The device of claim 1, wherein the power source is an on-board power source contained within or mounted to the device casing.

21. The device of claim 20, wherein the on-board power source is within a power source housing that is detachably mounted to the device casing.

22. The device of claim 1, wherein the power source is in a power source housing that is spaced apart from the device casing and electrically connectable to the flexible contacts.

23. The device of claim 1, further comprising a fluid conduit arranged to provide the conductive fluid from a fluid source to each of the first and second flexible contacts.

24. The device of claim 23, wherein the fluid source is a fluid reservoir contained within or mounted to the device casing.

25. The device of claim 24, wherein the fluid reservoir is detachable from the device casing.

26. The device of claim 24, wherein the power source is in a power source housing that is detachably mounted to the device casing; and
the fluid reservoir is located within the power source housing.

27. The device of claim 1, when used to electrolytically clean and passivate a weld in the conductive article.

28. The device of claim 1, when used to electrochemically etch a design, pattern or other form of marking into a surface of the conductive article.
